(19) United States
(12) Patent Application Publication
(10) Pub. No.: US 2015/0331959 A1
(43) Pub. Date: Nov. 19, 2015

(54) MERGED WEB CONTENT

(71) Applicant: Evan Michael FOOTE, West Lafayette, IN (US)

(72) Inventor: Evan Michael FOOTE, West Lafayette, IN (US)

(73) Assignee: Thomson Licensing

(21) Appl. No.: 14/438,918

(22) PCT Filed: Nov. 19, 2012
(86) PCT No.: PCT/US12/65822

§ 371 Date: Apr. 28, 2015

(51) Int. Cl. G06F 17/30; G06Q 30/02; H04L 29/08

(52) U.S. Cl. CPC G06F 17/30896; G06F 17/30905; H04L 67/02; G06Q 30/0277

(57) ABSTRACT

Requested and unrequested portions of a web page are merged by a dynamic content combiner before the web page is transmitted to a requester. The dynamic content combiner obtains unrequested portions such as advertising and requested portions such as web page content and constructs the web page before transmission. It then mergers at least a portion of the requested and unrequested portions into a single displayable object before transmitting the web page to a requester.

### BACKGROUND

Internet web pages can be constructed using information from many different servers. The content of the web page can be stored on a web page owner's server. However, the owner may sign up to place advertisements on their page to gain additional revenue. The actual advertisement can originate from a different server owned by the advertising agency. When a web user accesses the web page, it is constructed by contacting all associated servers for information. Thus, the content comes from one server while the advertisements come from a different server. Because of this, a user can employ an advertisement blocking utility that blocks all information not originating from the web owner's server. The advertising agency is transmitting the advertisement, but it is not reaching the user of the web page. In most cases, the web page owner will still receive remuneration for the placement of the advertisement even though it was not seen by the web page user. This greatly reduces the effectiveness of the advertisement and costs the advertiser money for little or no exposure.

### SUMMARY

An advertisement is constructed within standard Internet content such that is difficult to block with common advertising blocking techniques. Most websites generate revenue by displaying advertisements. However, some web browsers have addons or features which block flash advertisements, images bars, or other content from unknown sources. This limits the amount of revenue a site can receive or a prospective advertiser would be willing to pay. By constructing the content and advertisement together, it makes it difficult for third party applications to block advertising content.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a web page that contains both standard content and advertising content.

FIG. 2 is an example showing portions of a web page that are requested.

FIG. 3 is an example showing portions of a web page that are unrequested.

FIG. 4 is an example showing a web page with merged requested and unrequested portions.

FIG. 5 is an example system for merging requested and unrequested portions of a web page.

FIG. 6 is a method of merging requested and unrequested portions of a web page.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

An advertisement blocker works by identifying websites and items that stream content external to a current Internet web page, along with image or application frames that don't come from the current host. Instead of sending a request to get that content, the advertisement blocker will either delete it from the page or ignore it entirely. This leaves a web page without advertisements. To circumvent this, techniques disclosed herein composite an advertisement with a significant (not necessarily large) portions of a requested website/content. By compositing the advertisement with content, a user who wants to view an image, video, or whole format (such as flash application) has one of two choices—the user must block all or block none of the advertisement. If the user blocks the advertisement, they also block a significant portion of the web page, leaving it incomplete and without critical information.

On the content hosting side, the host must first have the web content available, and have the advertising content available. When a client requests the host's content, the host can then dynamically pick a section of the web page to compile along with the advertising content, then stream the rest of the page along with the mixed advertising and dynamically picked content in a compiled image/application form. When a user receives the compiled content, it will come from the same website as the requested content, and contain portions of the content critical to being complete. The bandwidth between the client and the content hosting server is increased over a web page that only contains content without being compiled with an advertisement. Thus, some bandwidth is sacrificed for guaranteed delivery of the advertising.

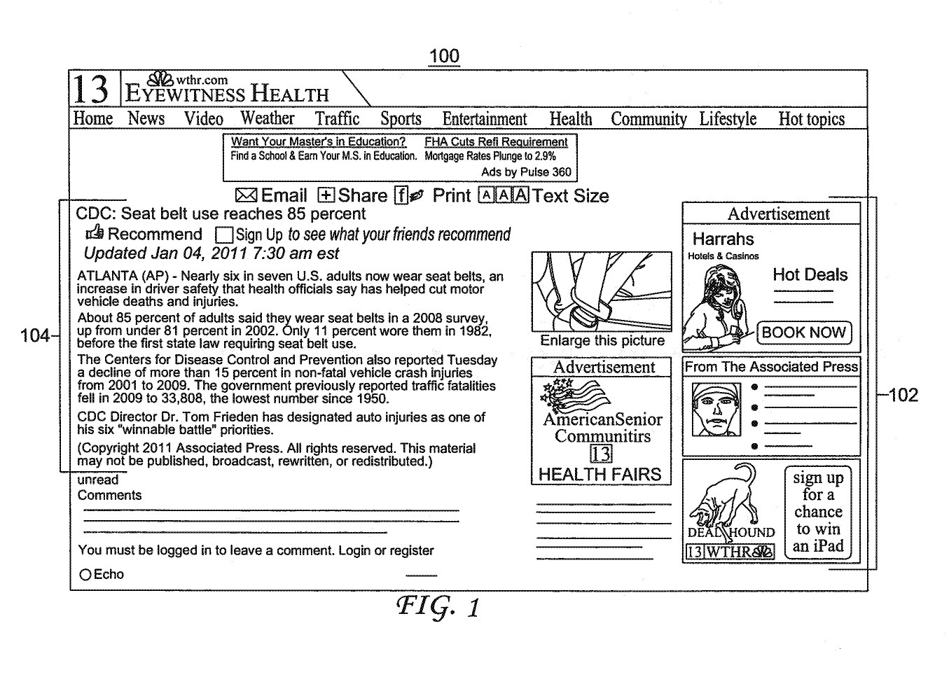

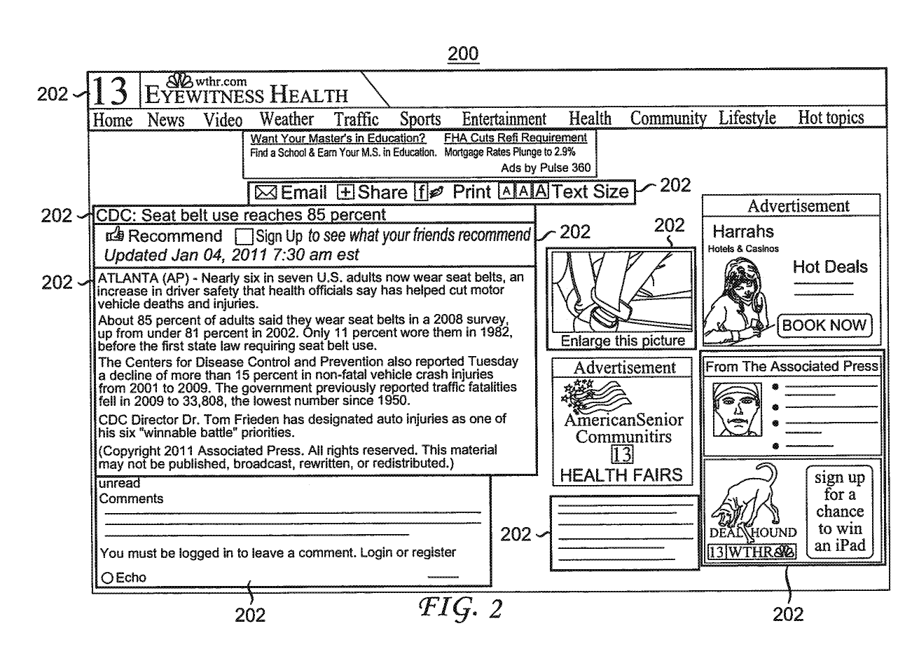

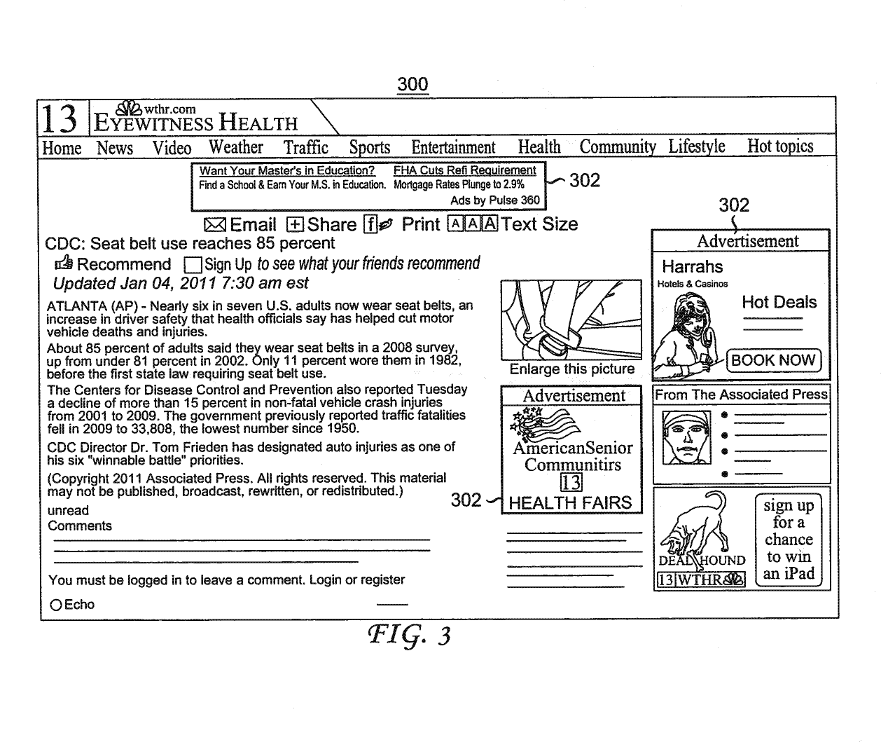

In one example, a web page contains many different objects, images and/or content. Each of these is a separate piece loaded from a different server (e.g., photos from a photo hosting server, content from a content hosting server, etc.). FIG. 1 illustrates a typical web page with various images 102 and content 104. FIG. 2 shows the web page 200 with highlighted portions indicating content that is requested 202 by a user. Requested content 202 is typically considered content that a user has originally requested and/or searched for and is desiring to view. Requested content can also include content that is associated with the originally requested content. For example, a user might search for information about a car. After clicking on a web page in a search results field, the user is shown content relating to the car but also content related to tires or a safety recall notice, etc. FIG. 3 shows the web page 300 with highlighted portions of the web page that are unrequested 302 in the sense that the user did not originally seek out this content (e.g., it is not directly associated content with the subject of a search and/or it is not the primary reason the user is viewing the content). Because the unrequested portions 302 are not critical to the requested or wanted content, the user may try to block this content with an advertisement and/or a script blocker and the like. This is possible because the user can still obtain the content that they seek even when a blocker is used. The only inconvenience that a user is subjected to is blank spaces where advertisements, etc. would have been normally displayed on a web page.

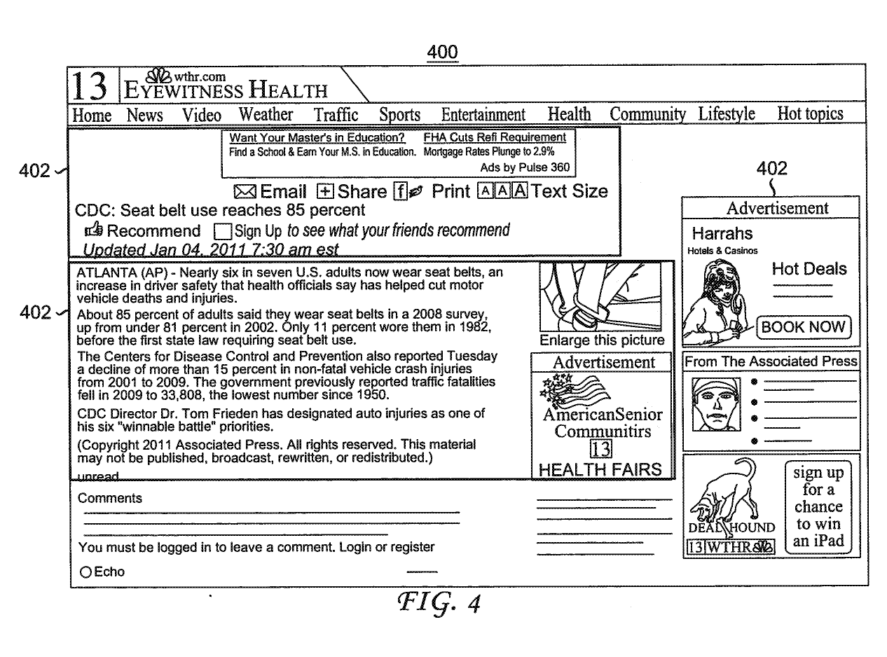

Applying the techniques disclosed herein, portions of the requested content 202 and the unrequested content 302 are identified, and merged, for example, as gif animation images into these highlighted objects 402 shown in FIG. 4. The merging of the two types of content does not have to be into a single displayed object (e.g., one gif animation) but can several displayed objects that when viewed together form a completed web page. The merging of the two types of content forces the user to view not only the requested content but also the unrequested content. If the user attempts to block the unrequested content, they will also block at least a portion of the requested content. The combination of the two types should be substantial enough that the user does not receive enough requested content to properly comprehend its meaning. In some cases, a single paragraph and/or multiple paragraphs can be combined with unrequested content. Although examples described and shown are primarily requested content in text form, the same techniques can be applied to image content and the like as well. The requested image content is merged or combined with unrequested text and/or images in the same manner as requested text content.

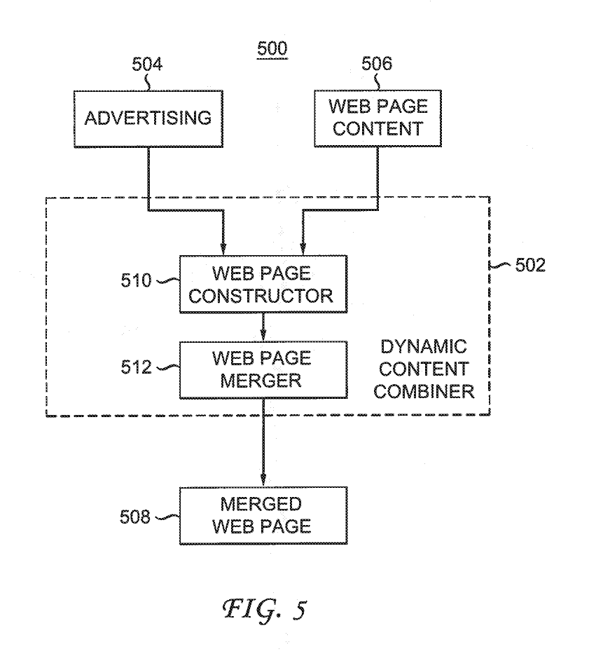

FIG. 5 is an example system 500 for merging requested and unrequested portions of a web page. The system 500 employs a dynamic content combiner 502 that incorporates advertising 504 and web page content 506 into a merged web page 508. The dynamic content combiner 502 utilizes a web page constructor 510 to create a completed web page with both advertising 504 and web page content 506. The constructed web page is completed in the sense that it is what a user or requester of the web page would see when normally viewing the web page. At this point, a user could easily block the advertising 504 if the web page were transmitted in this state. However, a web page merger 512 is then used to combine or merge portions of the web page content 506 with portions of the advertising 504. The web page merger 512 combines enough of the web page content 506 with the advertising 504 such that if the merged portion of the web page were blocked, it would substantially interfere with the user's comprehension of the web page content 506. It is not necessary to combine all portions of the web page content 506 with the advertising 504. Likewise, it is not necessary to combine all portions of the advertising 504 with a portion of the web page content 506. For example, this merge feature could be monetized such that only advertisers who pay a premium have their advertising combined with/merged with the web page content 506. In a similar fashion, a determination could be made as to the “value” of portions of the web page content 506 such that advertisers could pay a premium to be merged with higher valued portions of the web page content 506.

The web page merger 512 can employ different techniques for merging the advertising 504 and the web page content 506. For example, portions of each can be combined into single image formats like gifs, jpegs, etc. These merging techniques can be applied to form a single object that can encompass a majority of the web page and/or multiple single objects to encompass the majority of the web page. In a similar fashion, the techniques can be applied to only a portion of the web page. The dynamic content combiner 502 processes the web page dynamically such that a requester of the web page is not aware of the background processing and typically is not aware that portions of the web page have been combined/merged. Thus, the merged web page 508 is viewed like any other requested web page.

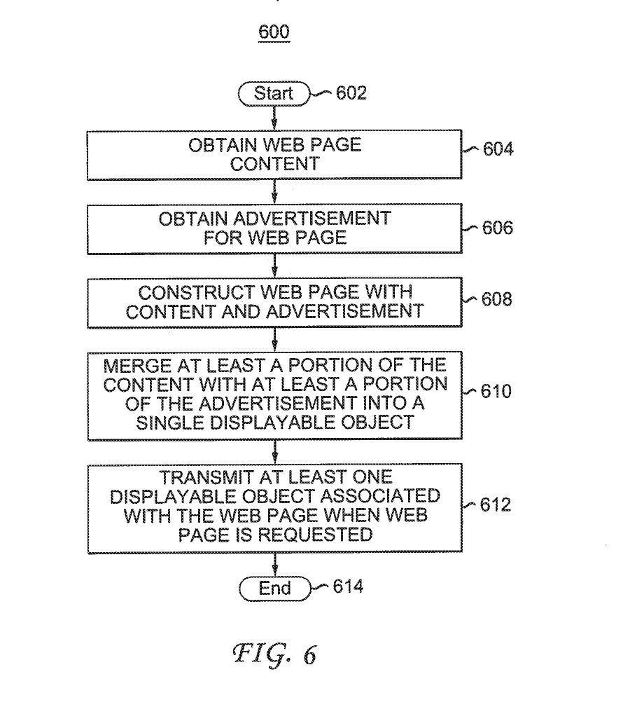

In view of the exemplary systems shown and described above, methodologies that can be implemented in accordance with the embodiments will be better appreciated with reference to the flow charts of FIG. 6. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 6 is a flow diagram of a method 600 of merging advertisements with web page content. The method starts 602 by obtaining web page content 604. The content can include textual content, image content and/or video content and the like. The web page content usually consists of material that would be viewed by a user when a web page is requested without any advertising or unrelated content included. A typical web page is formed by combining information from a host server and other servers. Web page content refers to content provided by the hosting server of the web page. An advertisement is then obtained for the web page from an advertising source 606. The advertising source is typically another server that hosts advertisements. However, it can also be the hosting server for the web page. In some cases, the advertisement can be the same advertisement each time the web page is viewed. In other cases, the advertisement can change each time the web page is viewed and/or viewer information (e.g., location, sex, time of day, etc.) can be used to determine which advertisement is used.

A web page is constructed with the web page content and the advertisement 608. At least a portion of the content is then merged with at least a portion of the advertisement into a single displayable object 610. A single displayable object is a web page object that is transmitted as a single entity and is intended to be displayed in its entirety on a web page. It would require additional effort by a web page browser to break the object apart before displaying it. Thus, a viewer of the web page is forced to view both the web page content and the advertising or risk blocking a desirable portion of the web page, At least one displayable object associated with the web page is transmitted when the web page is requested 612, ending the flow 614. It is not necessary to completely merge the entire web page content. For quickly displaying web pages and reducing processing time, only a strategic portion of the web page content needs to be merged with the advertising for the above techniques to be effective.

Although, the techniques have been described with advertising/advertisements being the “unrequested” portions of a web page, one skilled in the art can appreciate that other types of content can be used as the “unrequested” portions. Likewise, the “requested” portions could be advertising/advertisements and the like (e.g., for when a user is seeking to purchase an item or service they are seeking advertisements, etc.). In some cases, the “unrequested” portions can be textual content and the “requested” portions can be images and/or videos and the like. The techniques described above can be applied to these situations as well.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that processes web pages, comprising:
a web page constructor that constructs a web page from web page content and content hosted on a server other than a server hosting the web page content; and
a web page merger that merges at least a portion of the web page content with at least a portion of the content hosted on another server.

2. The system of claim 1, wherein the content hosted on another server is advertising content.

3. The system of claim 1, wherein the web page merger merges the portions into a single displayable object.

4. The system of claim 3, wherein the single displayable object is a gif animation.

5. The system of claim 1, wherein the web page merger merges a textual portion of the web page content with an advertising portion of the content hosted on another server.

6. The system of claim 1, wherein the web page merger merges an image portion of the web page content with an advertising portion of the content hosted on another server.

7. The system of claim 1, wherein the web page merger merges portions into at least one web page displayable object.

8. A method for processing web pages, comprising:
obtaining web page content from a hosting server;
obtaining content from a server other than the web page content hosting server; and
combining at least a portion of the web page content with at least a portion of the content from the other server into a displayable web page object.

9. The method of claim 8 further comprising:
transmitting the displayable web page object as web page content when the web page is requested.

10. The method of claim 8 further comprising:
combining a textual portion of the web page content with an advertising portion of the content from the other server.

11. The method of claim 8 further comprising:
combining an image portion of the web page content with a portion of the content from the other server.

12. The method of claim 8, wherein the displayable web page object is a gif animation.

13. The method of claim 8 further comprising:
processing the web page before the web page is transmitted to a web page requester.

14. A system that processes web pages, comprising:
a means for obtaining web page content from a hosting server;
a means for obtaining content from a server other than the web page content hosting server; and
a means for merging at least a portion of the web page content with at least a portion of the content from the other server into a displayable web page object.

15. The system of claim 14 further comprising:
a means for merging the portions into a gif animation.
